(19) United States
(12) Patent Application Publication
(10) Pub. No.: US 2007/0177589 A1
(43) Pub. Date: Aug. 2, 2007

(54) Network system and node redundancy method of network system

(75) Inventor: Akio Endo, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/451,726

(22) Filed: Jun. 13, 2006

(30) Foreign Application Priority Data
Jan. 31, 2006 (JP) 2006-21892

(51) Int. Cl. H04L 12/56

(52) U.S. Cl. 370/389; 370/401

(57) ABSTRACT

In a star type network which distributes loads by a plurality of multi-point switches MP-SWs, the information on the number of normal ports for each identifier of the logical connection is sent from an MP-SW to a slave SW, and the slave SW selects an MP-SW having a higher number of normal ports as the transfer destination of the data frame for each identifier. This node redundancy method can switch lines easily at high-speed when a link down occurs.

### CROSS-REFERENCE TO RELATED APPLICATIONS

This application is based upon and claims the benefit of priority from the prior Japanese Patent Application No. 2006-21892, filed on Jan. 31, 2006, the entire contents of which are incorporated herein by reference.

### BACKGROUND OF THE INVENTION

1. Field of the Invention

The present invention relates to a network system where a plurality of slave nodes are accommodated under a master node, the master node performs multi-point connection of the logical connections so that the slave nodes are connected to each other via the master node, and the node redundancy method of the network system.

2. Description of the Related Art

The star type network system is used for a corporate network, for example, since a network can be easily constructed at relatively low cost.

FIG. 1 is a diagram depicting a conventional star type network system. The star type network system comprises a master node, which is a multi-point switch (MP-SW), and a plurality of slave nodes accommodated there under, and two remote bases are connected by a logical connection via the master node.

One physical line can accommodate a plurality of logical connections, and each logical connection is identified by a logical connection identifier (hereafter called “identifier”) (e.g. a VLAN tag on Ethernet®). This logical connection is set one to one from the terminal of each base to the multi-point switch (MP-SW) which is the master node, and the MP-SW executes merging and distribution of logical connections having a same identifier. At this time, the communication of data frames is always executed exclusively within the logical connections with the same identifiers, and a data frame of a connection with an identifier is never transferred to a logical connection with another identifier. In FIG. 1, identifiers 10, 20 and 30 are assigned to each logical connection of the three users A, B and C respectively, so that the logical connection within one physical line is identified, and the logical connection (identifier 10) for connecting the bases 1, 2 and 3 of the user A, the logical connection (identifier 20) for connecting the bases 1, 2 and 3 of the user B, and the logical connection (identifier 30) for connecting the bases 1 and 2 of the user C are set.

In the case of the conventional star type network system shown in FIG. 1, all traffic is concentrated to the multi-point switch (MP-SW) which is the master node, so if a failure occurs to the MP-SW communication is disabled.

Japanese Patent Application Laid-Open No. S62-168431 discloses a line network system comprising an assistant central relay node, for assisting the master node (central relay), is installed, and if a failure occurs to the central relay node, the line is switched from the central relay node to the assistant central relay node by a switching unit.

Japanese Patent Application Laid-Open No. 2004-159205 discloses a network connection system where the networks are duplicated so that if a failure occurs, operation is switched to a backup network.

Since all traffic concentrates to the multi-point switch MP-SW, which is the master node, another possibility to solve this problem is to distribute processing to a plurality of MP-SWs so that the processing capability of the MP-SW and the link speed with slave nodes are increased.

FIG. 2 is a diagram depicting an example of a star type network system having a plurality of multi-point switches MP-SW. In FIG. 2, two MP-SWs, that is MP-SW-A and MP-SW-B, are installed. Each slave node (salve SW) sets a logical connection to either one of the MP-SWs, depending on the identifier of the logical connection. In FIG. 2, the logical connection with the identifier 10 or 20 is set to MP-SW-A, and the logical connection with the identifier 30 or 40 is set to the MP-SW-B. In this way, by installing a plurality of MP-SWs, load is distributed and the traffic volume that can be transferred can be increased.

In the network configuration in FIG. 2, in order to insure high reliability while load is distributed, the network may have a redundant structure, wherein if a failure occurs to one of the MP-SWs, the logical connection which is set to the failed MP-SW is switched to the other MP-SW which has not failed so that communication can be continued.

FIG. 3 is a diagram depicting an example of the redundancy configuration in the star type network system having a plurality of multi-point switches MP-SW. In the two MP-SWs, that is MP-SW-A and MP-SW-B, the logical connections with the identifiers 10, 20 and 40 are set to port 1, the logical connections with the identifiers 10, 30 and 40 are set to port 2, and the logical connections with the identifiers 20 and 30 are set to port 3, in other words, the same logical connections are set for MP-SW-A and MP-SW-B. The redundancy of the MP-SWs is implemented by three slave nodes (slave SW-C, slave SW-D and slave SW-E) selecting the MP-SW to transmit data frames.

In this case, for the identifiers 10 and 20, the logical connection connected with MP-SW-A is an operating line, and when all the ports are normal, the slave SW sends traffic only to MP-SW-A, and the logical connection connected to MP-SW-B is a backup line. For the identifiers 30 and 40, the logical connection connected to MP-SW-B is the operating line, and when all the ports are normal, the slave SW sends traffic only to MP-SW-B, and the logical connection connected to MP-SW-A is a backup line.

FIG. 4 is a diagram depicting a block configuration example of the slave node. The slave node comprises an IF unit 50, switch unit 60 and control unit 70. The IF unit 50 has a master IF and slave IF. The control unit 70 comprises a redundancy management unit 71 for managing the redundancy function of the master IF unit, and a connection management unit 72 for managing the switch information of the logical connection. The redundancy management unit 71 has redundancy management information for managing the physical lines (or master IF) for connecting with MP-SW, and determines the operating line and backup line for each identifier. To determine the operating line, the operator may explicitly set it, or the operating line is automatically determined (calculated by hash operation) by the identifier which is set. The redundancy management information is transferred to the connection management unit 72, and is reflected to the packet transfer table of the switch unit 60. The packet transfer table is a table storing the correspondence relationship between an input IF and output IF for each identifier, and is set by the connection management unit 72. The switch unit 60 switches the data frames according to the packet transfer table.

For up direction traffic (slave SW→MP-SW direction), data frames are transferred from the input IF (slave IF) of the slave node to the master IF of the operating line. If an abnormality occurs to the operating line (including the case when failure occurs to an MP-SW), the connection management function overwrites the packet transfer table so that the data frames are transferred to the master IF of the backup line.

For down direction traffic (MP-SW→slave SW direction), data frames which are input to the master IF of the slave node are transferred to the slave IF based on the packet transfer table (especially identifiers) without recognizing from which MP-SW the data frames were input (without identifying whether it is the master IF of the operating line or the master IF of the backup line).

FIG. 5 is a diagram depicting the operation when a failure occurs to MP-SW-A in the configuration in FIG. 3. In FIG. 5, if MP-SW-A fails, all slave SWs detect the link down in the lines with MP-SW-A. The connection management function of each slave SW updates the packet transfer table so that the operating line is switched from the master IF (P3) connected to MP-SW-A to the master IF (P4) connected to MP-SW-B. Therefore as shown in FIG. 5, the connection between the slave SW and MP-SW-B is normally restarted for all connections.

At this time, separated lines for distributing load are integrated into one physical line, and total traffic may exceed the capacity of the physical line. For example, in the case of the connection of the slave SW-C and MP-SW, normally the MP-SW-A side can use the physical line F1 to be the operating line until the total traffic volume of identifier 10 and identifier 20 becomes the physical line speed, and the MP-SW-B side can use the physical line F2 to be the operating line until the traffic volume of the identifier 40 becomes the physical line speed. If a failure occurs to MP-SW-A in this status, however, the traffic volume of the identifiers 10, 20 and 40 may exceed the physical speed of the physical line F2, and in this case, a congestion status occurs at the output side of port 4 of the slave SW-C. In this case, as FIG. 6 shows, a plurality of queues of the output IF are created for each physical port, and traffic with high priority and traffic with low priority are stored in different queues, so that discarding traffic with high priority can be prevented, even if congestion occurs at the output port. Priority of traffic may be determined for each identifier of the logical connection (e.g. identifiers=10 and 20 are H (priority: high) class, 30 and 40 are L (priority: low) class), or be determined considering the type of traffic in the identifier as well (e.g. VoIP traffic of identifier=10 is H class, other traffic is L class).

As described above, in normal status, traffic is distributed into two MP-SWs depending on the identifier of the logical connection, and when a node failure occurs, traffic is integrated into one MP-SW, so a node redundancy to prevent a communication disability can be implemented.

However with the above configuration, the following problems occur when a link between an MP-SW and the slave SW is disconnected.

FIG. 7 is a diagram depicting the line switching operation when a link down occurs between an MP-SW and the slave SW. In FIG. 7, if a link down occurs between the MP-SW-A and the slave SW-C, the slave SW-C switches the operating line of the identifiers 10 and 20 from the master IF (P3) connected to MP-SW-A to the master IF (P4) connected to MP-SW-B, but the slave SW-D and slave SW-E continuously send data frames for the identifiers 10 and 20 using the line connected to MP-SW-A as the operating line. Therefore these frames cannot be transferred to the slave SW-C even if they are sent MP-SW-A, since the link between MP-SW-A and slave SW-C is disconnected, so the communications of slave SW-D→slave SW-C and slave SW-E→slave SW-C are disabled. The communication of slave SW-C and slave SW-D or slave SW-E, however, is possible via MP-SW-B by the above switching operation.

To prevent such a communication disabled status, the lines of all logical connections may be switched to the lines connected to MP-SW-B by MP-SW-A, which detected the link disconnection, forcing all ports to link down status (same operation as FIG. 5), but in this case, the lines of logical connections unrelated to the failure may have to be switched together. Also a link down of all ports, because of the link down of one port of MP-SW, may cause a total shutdown of communication when the link down is detected in both MP-SWs.

If a method of the slave SW copying the same traffic and sending it to both MP-SWs and the receive side selecting the line is used, the generation of a communication shut down at a specific identifier can be prevented, even if the above mentioned link down is generated. In this case however, the slave SW always copies the traffic and sends it to both MP-SWs, so the load distribution for assigning the transmission destination MP-SW for each identifier cannot be implemented.

Another possible method is exchanging information between MP-SW-A and MP-SW-B and selecting an MP-SW to be connected with the operating line for each identifier, but high-speed switching is not possible since information must be exchanged between MP-SW-A, MP-SW-B and the slave SW when the operating line is switched.

With the foregoing in view, it is an object of the present invention to provide a node redundancy method which can perform high-speed switching easily and quickly when a link down occurs in a star type network system which has a plurality of multi-point switches for load distribution.

### SUMMARY OF THE INVENTION

To achieve the above object, according to an aspect of the present invention, a first configuration of the present invention is a network system having a plurality of master nodes and a plurality of slave nodes under the plurality of master nodes so that the master nodes perform multi-point connection of logical connections, wherein each master node notifies a number of normal ports for each logical connection to each slave node, and each slave node selects a traffic transfer destination master node out of the plurality of master nodes for each logical connection, based on the comparison of the number of normal ports received from each master node.

According to another aspect of the present invention, a second configuration of the network system is the first configuration wherein each slave node selects a master node having a higher number of normal ports out of the plurality of master nodes for each logical connection.

According to another aspect of the present invention, a third configuration of the network system is the first configuration wherein when the number of normal ports of each master node is the same for each logical connection, each slave node selects one master node, which is set in advance, out of the plurality of master nodes for each logical connection.

According to another aspect of the present invention, a fourth configuration of the network system is the first configuration wherein each master node notifies the number of normal ports to each slave node periodically or when the number of normal ports are changed, and each slave node updates the selection of the traffic transfer destination master node based on the received number of normal ports.

According to another aspect of the present invention, a first node redundancy method is a node redundancy method for a network system having a plurality of master nodes and a plurality of slave nodes under the plurality of master nodes, so that the master node performs multi-point connection of logical connections, the node redundancy method having a notification step in which each master node notifies a number of normal ports to each slave node for each logical connection, and a selection step in which each slave node selects a traffic transfer destination master node out of the plurality of master nodes for each logical connection, based on the comparison of the number of normal ports received from each master node.

According to another aspect of the present invention, a second node redundancy method is the first node redundancy method wherein each slave node selects a master node having a higher number of normal ports out of the plurality of master nodes for each logical connection in the selection step.

According to another aspect of the present invention, a third node redundancy method is the first node redundancy method, wherein when the number of normal ports of each master node is the same for each logical connection, each slave node selects one master node which is set in advance out of the plurality of master nodes of each logical connection in the selection step.

According to another aspect of the present invention, a fourth node redundancy method is the first node redundancy method, wherein each master node notifies the number of normal ports to each slave node periodically or when the number of normal ports are changed in the notification step, and each slave node updates the selection of the traffic transfer destination master node based on the received number of normal ports in the selection step.

According to another aspect of the present invention, a first configuration of the switch of the present invention is a switch for switching the traffic for each logical connection accommodated in a plurality of ports respectively, having a management unit for managing information on a number of normal ports for each logical connection, and a transmission unit for sending the information on the number of normal ports to a plurality of slave switches.

According to another aspect of the present invention, a second configuration of the switch of the present invention is a switch for switching the traffic for each logical connection accommodated in a plurality of ports respectively, having a receiving unit for receiving the information on a number of normal ports for each logical connection in each master switch, that is sent from a plurality of master switches respectively, and a selection unit for selecting a traffic transfer destination master switch for each logical connection, based on the comparison of the number of normal ports of each master switch received by the receiving unit, wherein traffic is switched to the port of the selected master switch for each logical connection.

According to another aspect of the present invention, a third configuration of the switch of the present invention is the switch of the second configuration, wherein the selection unit selects a master switch having a higher number of normal ports out of the plurality of master switches for each logical connection.

According to another aspect of the present invention, a fourth configuration of the switch of the present invention is the switch of the second configuration, wherein when the number of normal ports of each master switch is the same for each logical connection, a selection unit selects one master switch which is set in advance out of the plurality of master switches for each logical connection.

According to the present invention, the slave node selects a master node for each logical connection, so the switching of the master nodes is not performed for a logical connection which is not in link down status, and the switching is performed only for a logical connection which is in link down status, so unnecessary switching processing is not generated.

By one way information transmission (negotiation unnecessary) from the master node to slave node, the slave node can select the master node, so high-speed processing is possible.

Each master node broadcasts the number of normal ports to each slave node there under, so high-speed switching is possible regardless the number of slave nodes.

The switching operation to select a master node is executed only in the slave node, and the switching operation in the master node is unnecessary, so high-speed switching is implemented.

### BRIEF DESCRIPTION OF THE DRAWINGS

FIG. 1 is a diagram depicting an example of a conventional star type network system;

FIG. 2 is a diagram depicting an example of a star type network system having a plurality of multi-point switches MP-SW;

FIG. 3 is a diagram depicting an example of a redundancy configuration in a star type network system having a plurality of multi-point switches MP-SW;

FIG. 4 is a diagram depicting a block configuration example of a slave node;

FIG. 5 is a diagram depicting an operation when a failure occurs to MP-SW-A in the configuration in FIG. 3;

FIG. 6 is a diagram depicting the priority control of the output port;

FIG. 7 is a diagram depicting the line switching operation when link down occurs between an MP-SW and a slave SW;

FIG. 8 is a diagram depicting the network system according to the present embodiment;

FIG. 9 shows a format example of the control frame for sending the above information from an MP-SW to a slave SW;

FIG. 10 is a diagram depicting a block configuration example of a multi-point switch MP-SW according to the present embodiment;

FIG. 11 is a diagram depicting a block configuration example of a slave switch according to the present embodiment;

FIG. 12 is a diagram depicting the switching operation when a link down occurs according to the present embodiment; and

FIG. 13 is a processing flow chart depicting the switching operation according to the present embodiment.

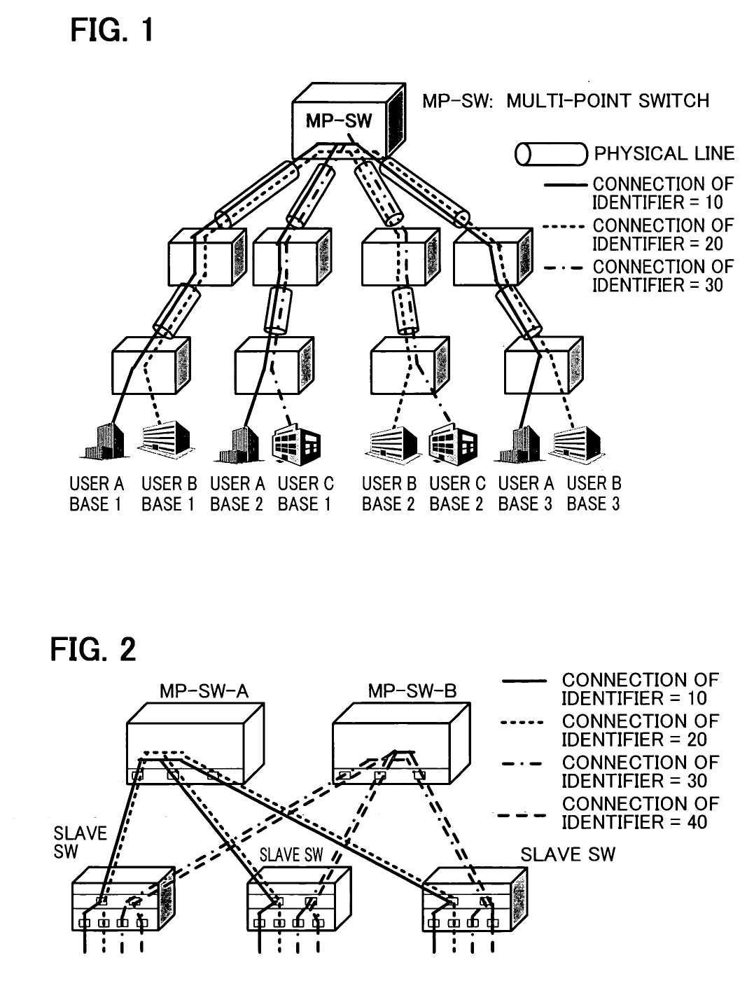

### DESCRIPTION OF THE PREFERRED EMBODIMENTS

Embodiments of the present invention will now be described. These embodiments however shall not be for limiting the technical scope of the present invention.

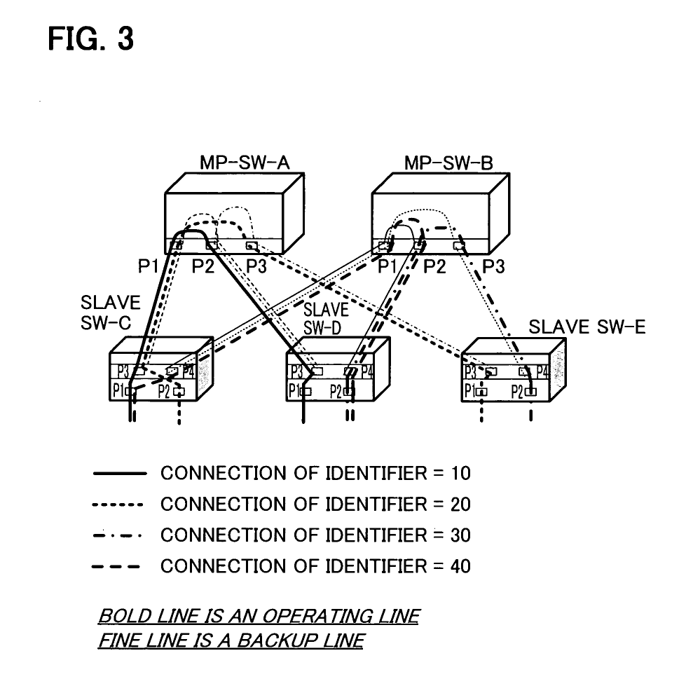

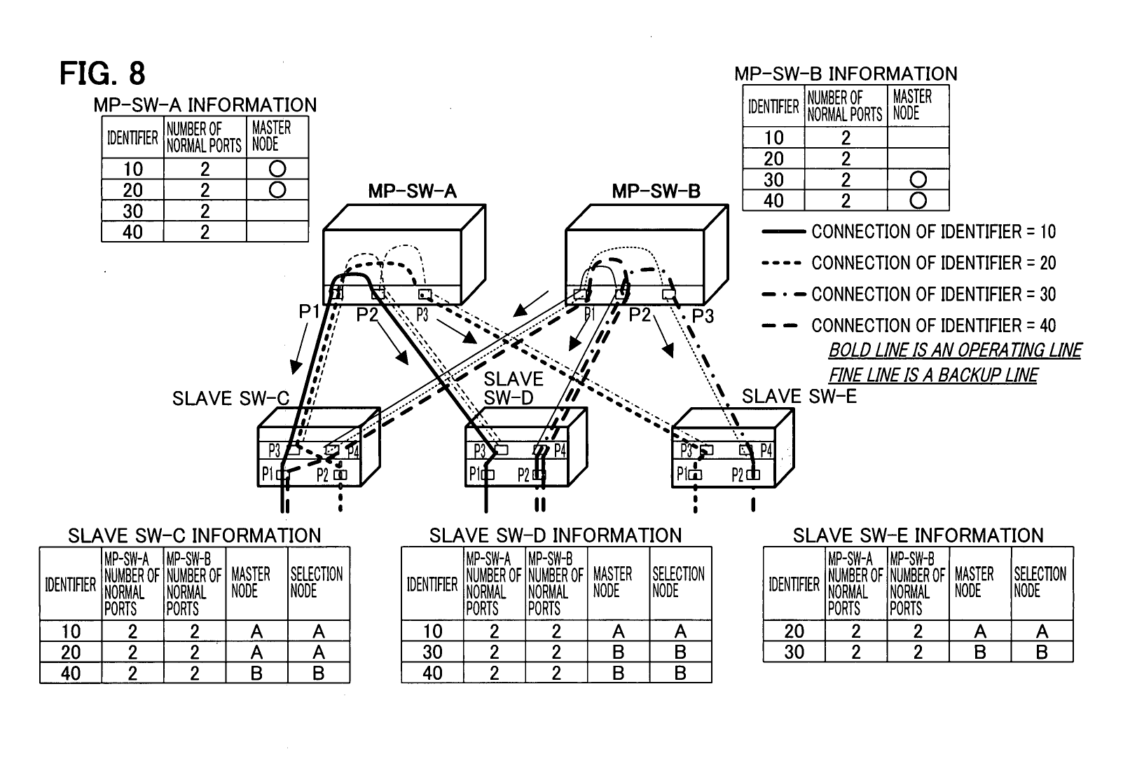

FIG. 8 is a diagram depicting the network system according to a present embodiment. The network configuration in FIG. 8, which is the same as the configuration in FIG. 3, is a star type network system having a plurality of multi-point switches MP-SW (master nodes), and a plurality of MP-SWs which form a redundancy configuration. In two master nodes MP-SW-A and MP-SW-B, logical connections with identifiers 10, 20 and 40 are set to port 1, logical connections with identifiers 10, 30 and 40 are set to port 2, and logical connections with identifiers 20 and 30 are set to port 3, and three slave nodes (slave SW-C, slave SW-D and slave SW-E) select a data frame transmission destination MP-SW, thus the redundancy of MP-SW is implemented.

At this time, in the slave SW, the logical connection connected to MP-SW-A is an operating line for the identifiers 10 and 20, and when all the ports are in normal status, traffic is sent only to MP-SW-A, and the logical connection connected to MP-SW-B is a backup line. For the identifiers 30 and 40, the logical connection connected to MP-SW-B is an operating line, and when all the ports are in normal status, traffic is sent only to MP-SW-B, and the logical connection connected to MP-SW-A is a backup line.

In this network configuration, according to the present invention, each MP-SW has information on (1) the number of ports being set (number of normal ports), and (2) whether this MP-SW is the master node, for each identifier, and sends a control frame including this information to a slave SW periodically or when a change is made. The MP-SW-A information shown in FIG. 8 is table information having the number of normal ports information and the master node information on MP-SW-A, and the MP-SW-B information is table information having the number of normal ports information and the master node information on MP-SW-B.

For example, in the MP-SW-A information, MP-SW-A has two ports, port 1 and port 2, to be connected with logical connection with identifier 10, two ports, port 1 and port 3, to be connected with logical connection with identifier 20, two ports, port 2 and port 3, to be connected with logical connection with identifier 30, and two ports, port 1 and port 2, to be connected with logical connection with identifier 40. For the identifiers 10 and 20, the logical connection to be connected with MP-SW-A is an operating line (main line) used during normal time, so MP-SW-A is a master node for identifiers 10 and 20.

MP-SW-B is also the same as above, and MP-SW-B has two ports, each for identifiers 10, 20, 30 and 40, and becomes a master node for identifiers 30 and 40.

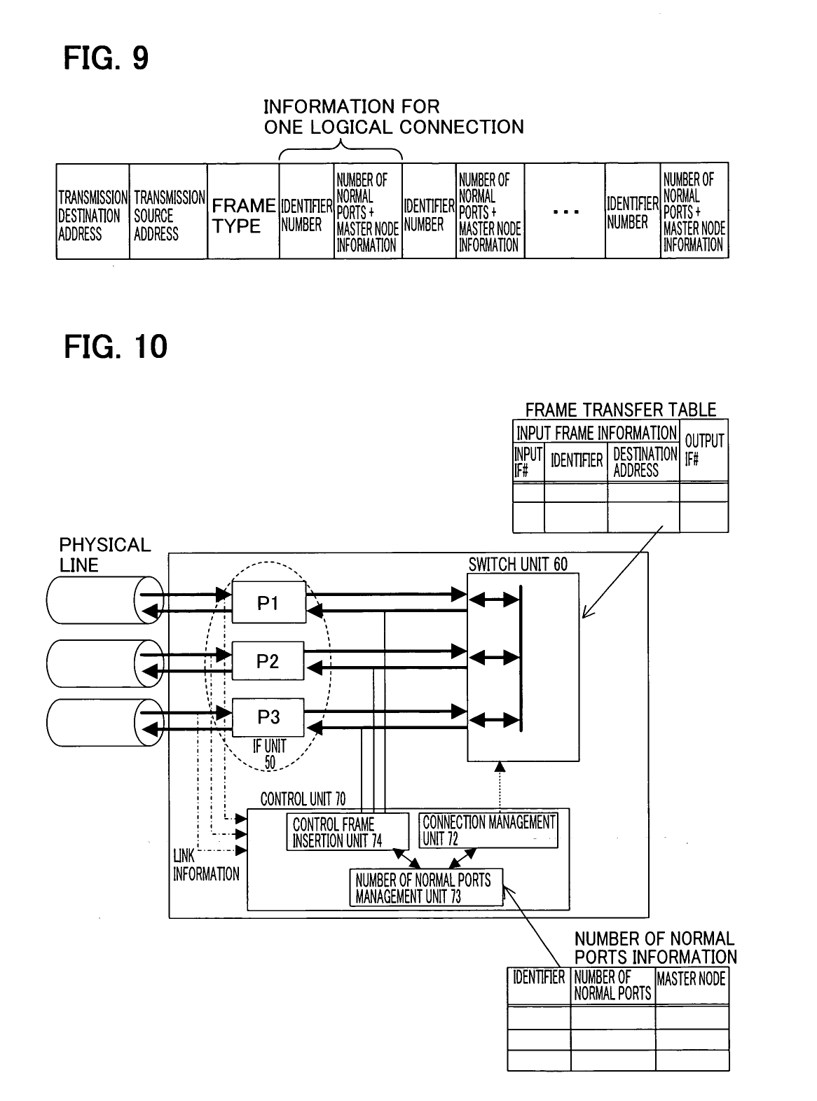

FIG. 9 shows a format example of a control frame for sending the above information from an MP-SW to a slave SW. As FIG. 9 shows, for instance, the number of control frames to be transferred can be controlled by inserting information on a plurality of identifiers into one control frame. The information included in the control frame to be transmitted from each port of MP-SW may be common for each part of MP-SW (that is, including information on all the identifiers), or may be information only on the identifier(s) of the logical connection to be connected with the port.

When the slave SW-C, slave SW-D and slave SW-E receive a control frame transmitted from MP-SW-A and MP-SW-B, the slave SW-C, slave SW-D and slave SW-E hold the information included in the control frame as table information. The slave SW-C information, slave SW-D information and slave SW-E information shown in FIG. 8 include the number of normal port information and the master node information for MP-SW-A and MP-SW-B respectively for each identifier based on the information included in the received control frame, and whether the logical connection connected with MP-SW-A is selected or the logical connection connected with MP-SW-B is selected is judged for each identifier, and the result is stored as the “selection node information”.

The selection node decision rule is as follows. Each slave SW compares the number of normal ports information of MP-SW-A and MP-SW-B for each identifier, and selects the MP-SW having a higher number of normal ports, and for the corresponding identifier, each slave SW sends the data frame using the logical connection to be connected with the selected MP-SW. If the number of normal ports is the same (e.g. the case when both MP-SW-A and MP-SW-B are operating normally), the MP-SW in master node status is selected.

In the case of the example in FIG. 8, the number of normal ports is the same for MP-SW-A and MP-SW-B registered in each slave SW, and the master node is selected as a selection node. Specifically for the identifiers 10, 20 and 40, the slave SW-C compares the information between the control frame received from MP-SW-A and the control frame received from MP-SW-B, selects MP-SW-A as a selection node and sends the traffic in the up direction only to P3 for the identifiers 10 and 20. In the same way, for the identifier 40, the slave SW-C selects MP-SW-B as a selection node, and sends the traffic in the up direction only to P4.

FIG. 10 is a diagram depicting a block configuration example of the multi-point switch MP-SW according to the present embodiment. The MP-SW comprises the IF unit 50, switch unit 60 and control unit 70. The IF unit 50 has ports P1, P2 and P3 connected with the physical line for accommodating logical connections, and the switch unit 60 switches the data frame according to the frame transfer table where the input port and the output port are corresponded for each identifier.

The control unit 70 comprises a connection management unit 72 for managing the frame transfer table, a number of normal ports management unit 73 for managing the number of normal ports for each identifier, and a control frame insertion unit 74 for generating and inserting the control frame shown in FIG. 9. The connection management unit 72 generates and stores the frame transfer table, and updates the frame transfer table when the logical connections are increased or decreased. The number of normal ports management units 73 generates and stores the MP-SW information shown in FIG. 8, and updates the MP-SW information when the logical connections are increased or decreased and when a link down occurs. As described above, the MP-SW information is sent to the slave SW as a control frame by the control frame insertion unit 74.

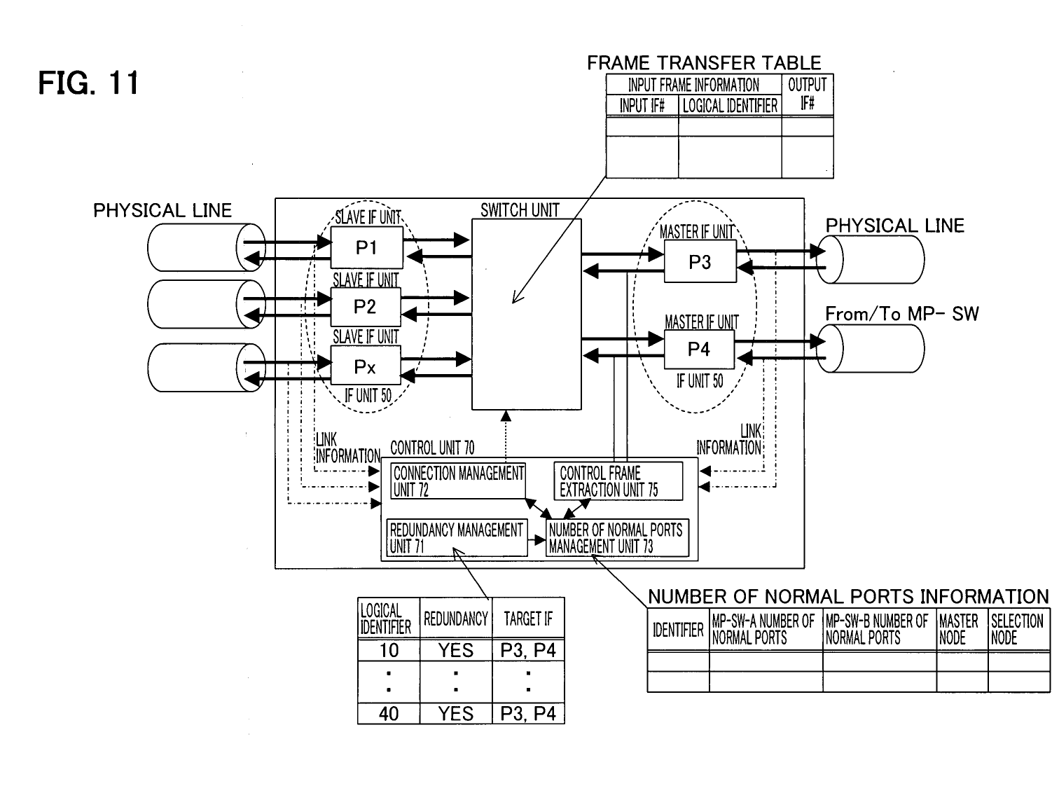

FIG. 11 is a diagram depicting a block configuration example of the slave switch according to an embodiment of the present invention. The slave SW comprises the IF unit 50, switch unit 60 and control unit 70. The IF unit 50 of the slave SW has essentially the same configuration as that of the MP-SW in FIG. 10. The IF unit 50 of the slave SW is described separately for the slave IF unit and the master IF unit, but this is merely for convenience, referring to the port connected to another slave SW at the lower layer of the slave SW as the “slave IF unit”, and the port connected to the MP-SW is referred to as the “master IF unit”, and the functions thereof have no difference. The switch unit 60, just like that of MP-SW in FIG. 10, switches the data frame according to the frame transfer table where the input port and the output port are corresponded to each other for each identifier.

The control unit 70 comprises the redundancy management unit 71, the connection management unit 72 for managing the frame transfer table, the number of normal ports management unit 73 for managing the number of normal ports for each identifier, and the control frame extraction unit 74 for receiving and extracting the control frame shown in FIG. 9.

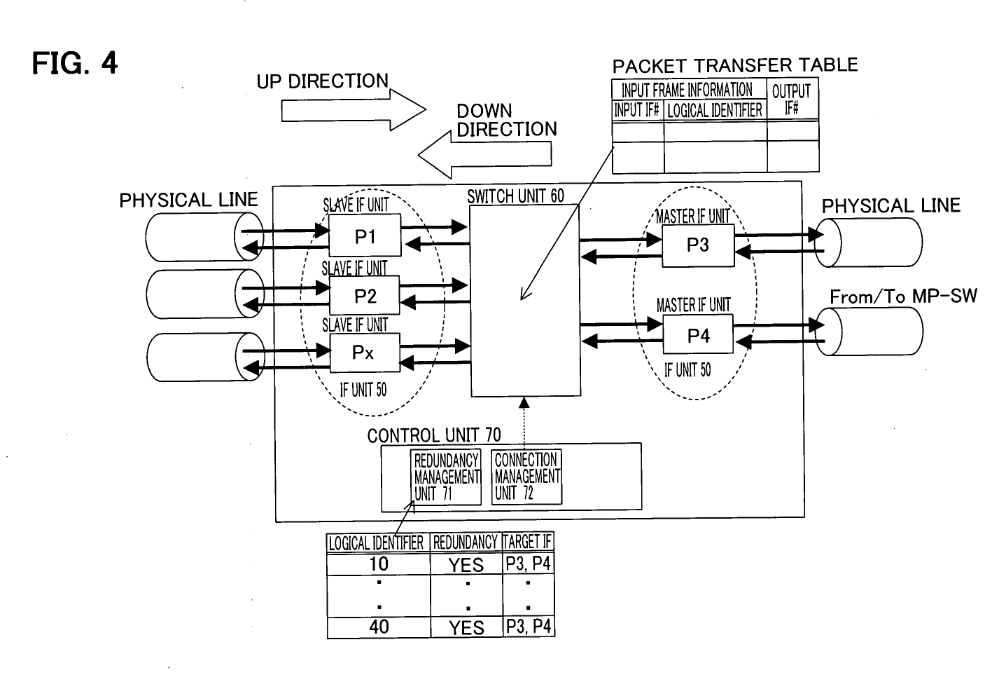

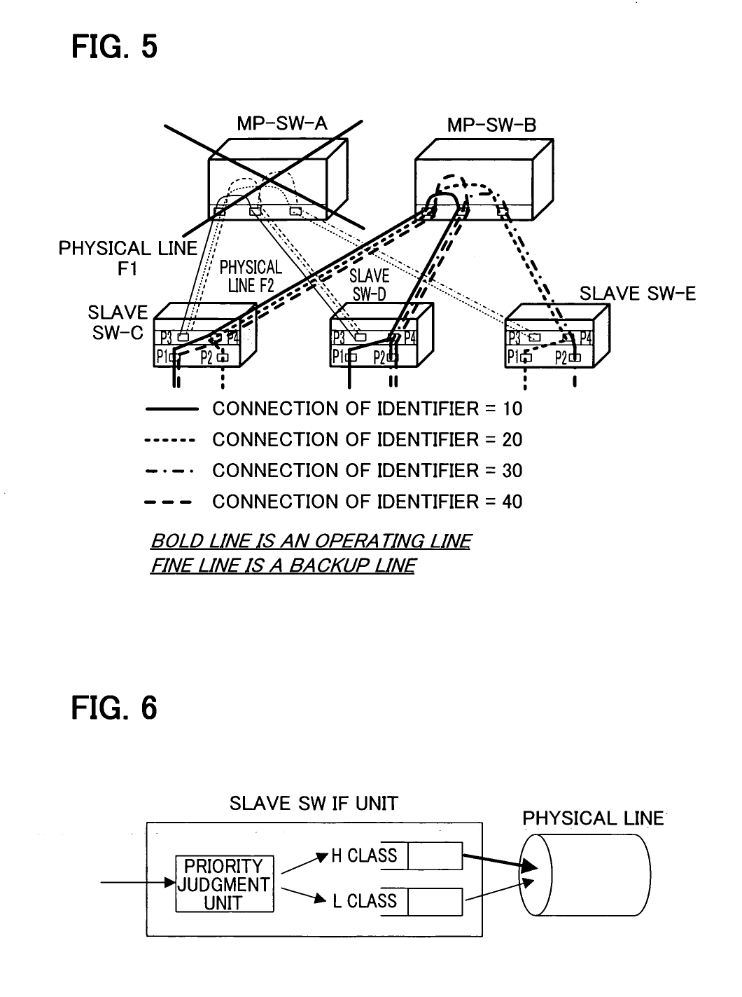

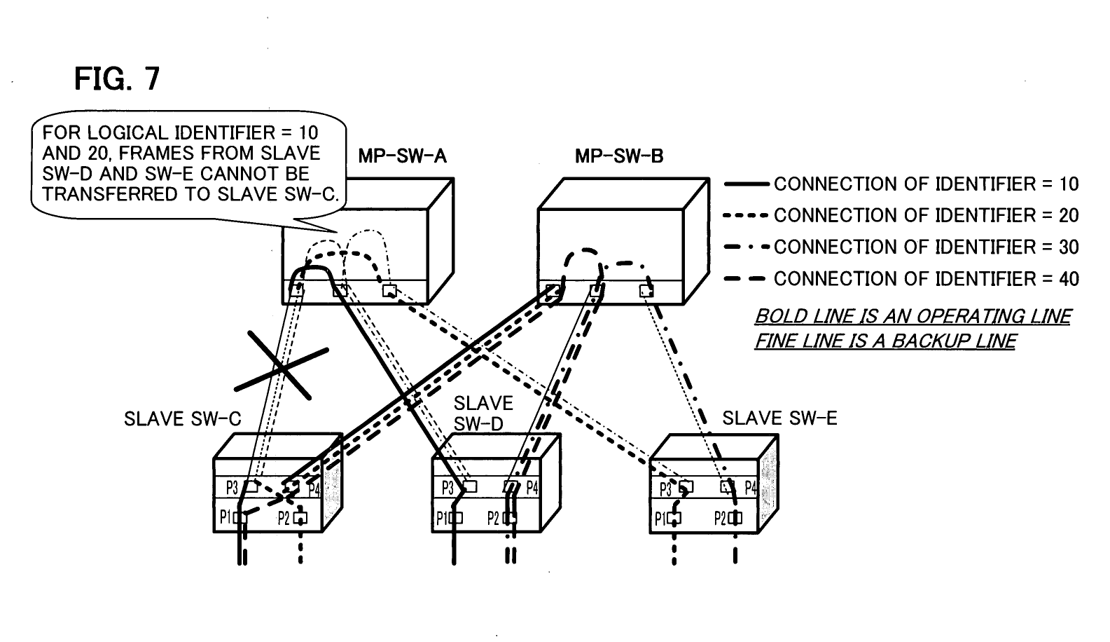

The redundancy management unit 71, similarly to the configuration in FIG. 4, has a redundancy management information for managing the ports (master IF) of the physical line connected to MP-SW, and in the redundancy management information, a plurality of ports connected to different MP-SWs respectively are set for each identifier if redundancy is active.

The connection management unit 72, just like that of the MP-SW in FIG. 10, generates and holds the frame transfer table, and updates the frame transfer table when the logical connections are increased or decreased.

The number of normal ports management unit 73 generates and stores the slave SW information shown in FIG. 8, and updates the slave SW information including the number of normal ports and the master node information for each identifier, based on the control frame extracted by the control frame extraction unit 74. And the number of normal ports management unit 73 compares the number of normal ports of MP-SW-A and the number of normal ports of MP-SW-B, and determines the selection node (MP-SW) to which the data frame is transferred for each identifier. The selection node determined by the number of normal ports management unit 73 is notified to the connection management unit 72, and if the selection node is changed, the connection management unit 72 updates the output IF of the corresponding identifier, to the port connected to the changed selection node.

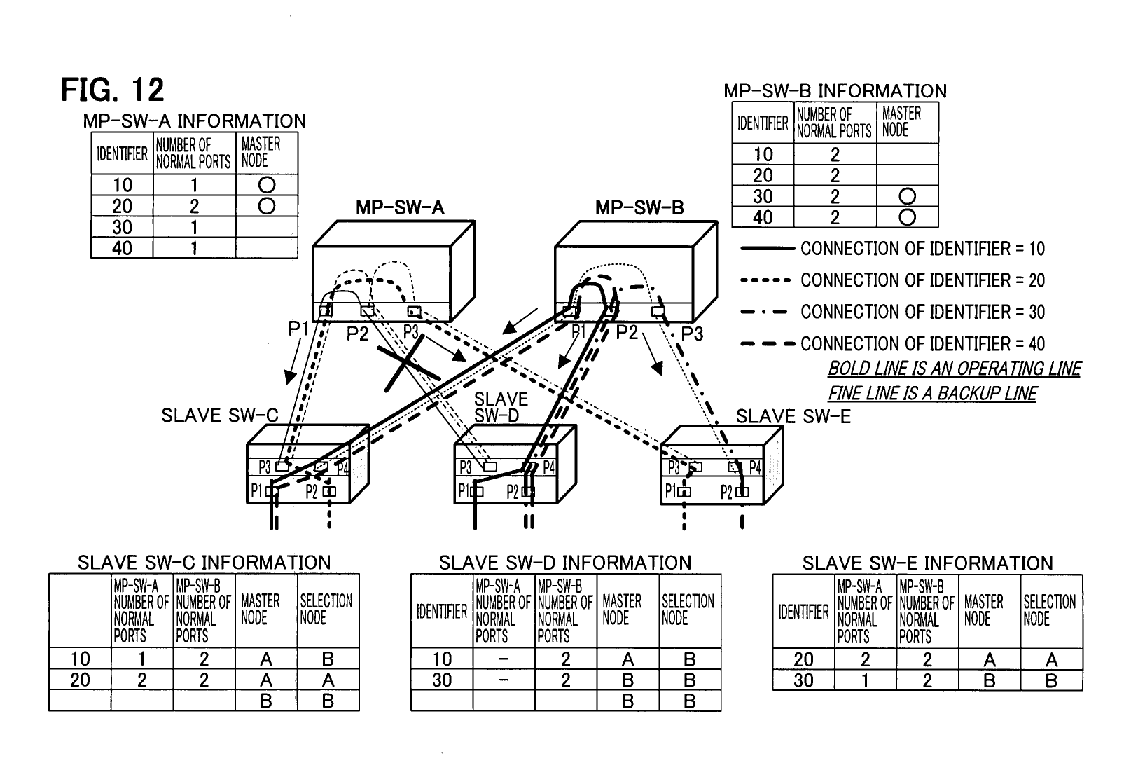

FIG. 12 is a diagram depicting the switching operation when a link down occurs according to an embodiment of the present invention. MP-SW-A detects the link down in port P2 connected to the slave SW-D. In other words, MP-SW-A detects that a failure occurred to the physical line connecting the port P2 of MP-SW-A and the port P3 of the slave SW-D. The slave SW-D also detects this link down.

By this, the number of normal ports management unit 73 of MP-SW-A changes the number of normal ports of logical connection with the identifiers 10, 30 and 40 being set in the port P2 of MP-SW-A from 2 to 1. The number of normal ports management unit 73 also transfers the control frame including this changed number of normal ports information to each slave SW-C and slave SW-E. The transmission to the slave SW-D is disabled by the link down, but the slave SW-D also detects this link down the same way as mentioned above.

The slave SW-C and the slave SW-E receive a control frame from MP-SW-A and updates the information on the identifiers 10, 30 and 40 in the respective slave SW information. As a result, in the slave SW-C information shown in FIG. 12, the number of normal ports notified from MP-SW-A (=1) is smaller than the number of normal ports notified from MP-SW-B (=2) for the identifier 10 (the number of normal ports of MP-SW-B is greater), so the selection node is changed from MP-SW-A to MP-SW-B. Therefore the operating line is switched from the port P3, connected to MP-SW-A, to the port P4, connected to MP-SW-B for the identifier 10, and the data frame with the identifier 10 in the up direction traffic is output from the port P4.

For the identifier 30 in the slave SW-C and the identifier 40 in the slave SW-E, the operating line (port) connected to MP-SW-B has been selected before the detection of the link down, so the selection node remains the same as MP-SW-B, even if the number of normal ports of MP-SW-B becomes greater.

The slave SW-D, which detected the link down of the line with MP-SW-A, recognizes that the number of normal ports of MP-SW-A for the identifiers 10, 30 and 40 is zero, and the number of normal ports of MP-SW-A for the identifiers 10, 30 and 40 is updated to zero in the slave SW-D information. As a result, in the slave SW-D information shown in FIG. 12, the number of normal ports of MP-SW-A (=0) becomes smaller than the number of normal ports notified from MP-SW-B (=2) for the identifier 10 in the slave SW-D information shown in FIG. 12 (the number of normal ports of MP-SW-B is greater), so the selection node is changed from MP-SW-A to MP-SW-B. Therefore the operating line is switched from the port P3 connected to MP-SW-A to the port P4 connected to MP-SW-B for the identifier 10, and the data frame with the identifier 10 in the up direction traffic is output from the port P4. For the identifiers 30 and 40 in the slave SW-D information, the operating line (port) connected with MP-SW-B has been selected before the detection of the link down, so the selection node remains the same as MP-SW-B, even if the number of normal ports of MP-SW-B becomes greater.

In this way, all the slave SWs related to the identifier 10 (slave SW-C and slave SW-D in the case of this example) select MP-SW-B as the transmission destination of the data frame with the identifier 10, and normal communication of the data frame with the identifier 10 is restarted via MP-SW-B.

For the connection with the other identifiers, the selection node is not changed, so normal communication continues via the same MP-SW before and after the link down, and a traffic disconnection by switching the selection node does not occur. Selection node switching has the same meaning as line switching.

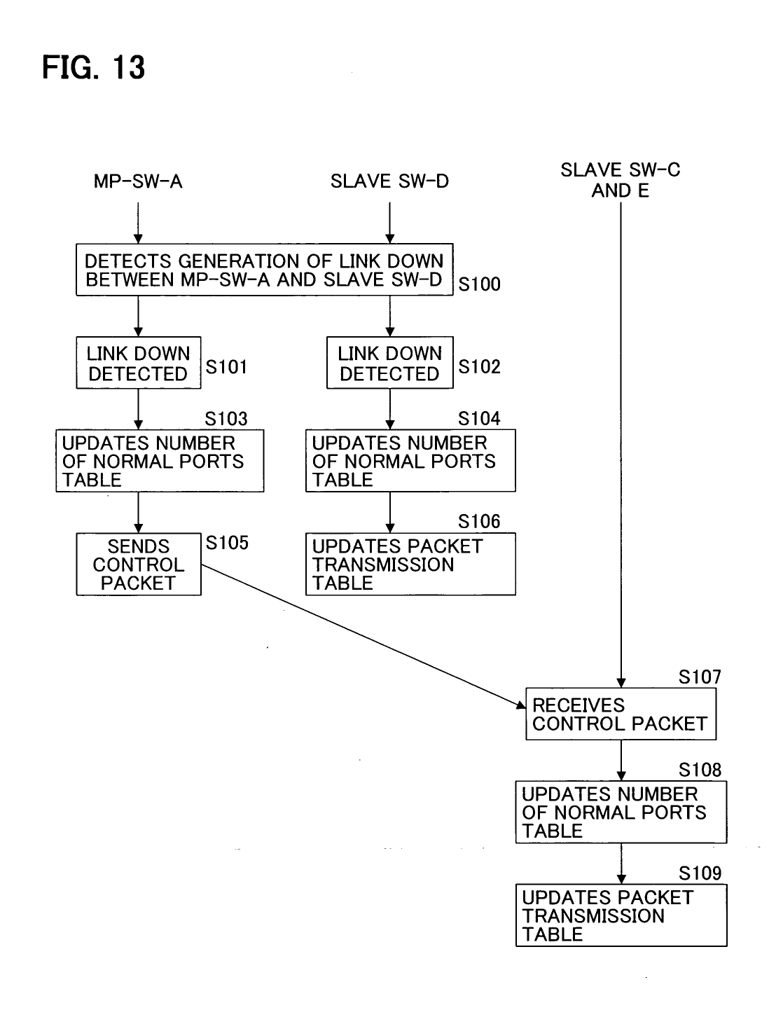

FIG. 13 is a processing flow chart depicting the above mentioned switching operation. In FIG. 13, when a link down occurs between MP-SW-A and the slave SW-D (S100), the link down is detected in MP-SW-A and slave SW-D respectively (S101, S102). MP-SW-A and the slave SW-D update the number of normal ports information of the MP-SW-A information and the slave SW-D information respectively (S103, S104), and MP-SW-A sends the control frame, including the updated number of normal ports information, to the slave SW-C and slave SW-E (S105). The slave SW-D judges the selection node based on the updated number of normal ports, and if the selection node is changed, this slave SW-D updates the selection node information of the slave SW-D information (S104), and updates the packet transfer table (S106).

When the slave SW-C and slave SW-E receive the control frame from MP-SW-A (S107), the slave SW-C and slave SW-E update the number of normal ports information of the respective slave SW information based on the updated number of normal ports included in the control frame (S108), judges the selection node by comparing the updated number of normal ports, and updates the selection node information of the slave SW-C information and slave SW-E information if the selection node is changed (S108), and also updates the packet transfer table (S109).

As described above, according to the present invention, in the star type network where load is distributed by a plurality of multi-point switches MP-SWs, the number of normal ports information is sent from an MP-SW to a slave SW for each identifier of logical connection, and the slave SW side selects the MP-SW having a higher number of normal ports as the data frame transfer destination for each identifier. Therefore a same MP-SW is always selected for each identifier, so communication in a logical connection is quickly recovered even if a failure (link down) occurs. MP-SW is switched for each identifier of logical connection, so communication of logical connections not related to a failure is not affected (switching of MP-SW is not generated).

The control frame for notifying the number of normal ports is sent only one way, from a multi-point switch MP-SW to a slave SW, in other words, a line can be switched only by a one way transmission of this control frame without the negotiation of MP-SW and the slave SW in both directions. Communication protocol can be simplified, and the processing procedure can also be simplified, so high-speed switching can be implemented. For the control frame, a same control frame is broadcasted from MP-SW to the slave SW, so the switching time does not depend on the number of slave SWs.

What is claimed is:

1. A network system comprising:
a plurality of master nodes performing multi-point connection of logical connections; and
a plurality of slave nodes under said plurality of master nodes,
wherein each master node notifies a number of normal ports for each logical connection to each slave node, and each slave node selects a traffic transfer destination master node out of said plurality of master nodes for each logical connection, based on the comparison of said number of normal ports received from each master node.

2. The network system according to claim 1, wherein each slave node selects a master node having a higher number of normal ports out of said plurality of master nodes for each logical connection.

3. The network system according to claim 1, wherein when the number of normal ports of each master node is the same for each logical connection, each slave node selects one master node which is set in advance out of said plurality of master nodes for each logical connection.

4. The network system according to claim 1, wherein each master node notifies said number of normal ports to each slave node periodically or when the number of normal ports are changed, and each slave node updates the selection of the traffic transfer destination master node based on said received number of normal ports.

5. A node redundancy method for a network system which comprises a plurality of master nodes performing multi-point connection of logical connections and a plurality of slave nodes under said plurality of master nodes, the node redundancy method comprising:
a notification step in which each master node notifies a number of normal ports for each logical connection to each slave node; and
a selection step in which each slave node selects a traffic transfer destination master node out of said plurality of master nodes for each logical connection, based on the comparison of said number of normal ports received from each master node.

6. The node redundancy method according to claim 5, wherein each slave node selects a master node having a higher number of normal ports out of said plurality of master nodes for each logical connection in said selection step.

7. The node redundancy method according to claim 5, wherein when the number of normal ports of each master node is the same for each logical connection, each slave node selects one master node which is set in advance out of said plurality of master nodes for each logical connection in said selection step.

8. The node redundancy method according to claim 5, wherein each master node notifies said number of normal ports to each slave node periodically or when the number of normal ports are changed in said notification step, and each slave node updates the selection of the traffic transfer destination master node based on said received number of normal ports in said selection step.

9. A switch for switching traffic for each logical connection accommodated in a plurality of ports respectively, comprising:
a management unit for managing information on a number of normal ports for each logical connection, and
a transmission unit for transmitting the information on said number of normal ports to a plurality of slave switches.

10. A switch for switching traffic for each logical connection accommodated in a plurality of ports respectively, comprising:
a receiving unit for receiving information on a number of normal ports for each logical connection in each master switch, that is sent from a plurality of master switches respectively; and
a selection unit for selecting a traffic transfer destination master switch for each logical connection, based on the comparison of the number of normal ports of each master switch received by said receiving unit, wherein
traffic is switched to the port of said selected master switch for each logical connection.

11. The switch according to claim 10, wherein said selection unit selects a master switch having a higher number of normal ports out of the plurality of master switches for each logical connection.

12. The switch according to claim 10, wherein when the number of normal ports of each master switch is the same for each logical connection, said selection unit selects one master switch which is set in advance out of said plurality of master switches.
